(19) United States
(12) Patent Application Publication
(10) Pub. No.: US 2004/0118510 A1
(43) Pub. Date: Jun. 24, 2004

(54) Adhesive backed graphite foil gasket and processes for making the same

(75) Inventors: Mark W. Pollock, Avon, OH (US); John H. Jackson, Houston, TX (US); Albert J. Mariconda, Doylestown, PA (US); Steven A. Shane, Avon Lake, OH (US)

Correspondence Address: Timothy R. Krogh, Graftech Inc., Suite 301-Brandywine West Bldg, 1521 Concord Pike, Wilmington, DE, 19803, US

(73) Assignee: Graftech, Inc., Wilmongton, DE (US)

(21) Appl. No.: 10/326,463

(22) Filed: Dec. 20, 2002

(51) Int. Cl. B32B 31/00

(52) U.S. Cl. 156/256; 156/289

(57) ABSTRACT

Adhesive-backed graphite foil rings (62,64) are suited to forming a seal between a metal gasket plate (12) and adjacent pipe flanges (40, 42). To form the rings, a thin layer of adhesive (74) is applied in the form of a coating to a flexible graphite sheet (70). A release liner (80) may be applied over the adhesive layer. The rings (62,64) are cut from the adhesive coated flexible graphite sheet. In one method, the rings are die cut while leaving the release liner intact. After removal of extraneous material, a plurality of the rings remain attached to the release liner and can be peeled away from the liner as needed. In another method, a central cut-out portion (102) from a large adhesive-backed ring is later used to form a smaller adhesive-backed ring.

### BACKGROUND OF THE INVENTION

1. Field of the Invention

The invention relates to a method of forming a gasket. In particular, it relates to a method of forming a gasket facing from a flexible graphite material with an adhesive backing and attachment of the facing to a corrugated or serrated metal insert.

2. Discussion of the Art

Pipes are used to transfer liquids and gases in processing plants, such as refineries, chemical plants, power plants, and the like. These fluids are often at high temperatures and pressures. In routing pipes through the processing plants, sections of pipe are connected together, often by annular flanges. The flanges are rigidly connected to a respective end of the pipe sections to be joined. Bolts, passing through the flanges, are secured by nuts to hold the flanges in position. A gasket is used to seal the connection of the two flanges. The gasket creates a seal by deforming and filling surface irregularities between the mating flange surfaces. One such gasket is described, for example, in U.S. Pat. No. 5,785,322 to Suggs, et al., which describes expanded graphite particles in the shape of worms which are compressed between ridges of a corrugated annular metal insert. The graphite sealing material contacts the faces of the flanges to seal against fluid leakage through the rigidly connected flange joint.

In another gasket, the corrugated annular region of the metal insert comprising the ridges and grooves receives a facing cut from a sheet of expanded graphite. The graphite facing seals the flange joint. To adhere the graphite facing to the metal insert, an adhesive is applied. In one method, a plastic carrier sheet is coated on both sides with a layer of an adhesive. One of the adhesive layers is attached to a sheet of expanded graphite while the other is attached to a metal insert. A razor knife is used to trim the facing to the desired size, after application to the metal insert. One problem with this method is that the two layers of adhesive and carrier material in combination make for a relatively thick layer intermediate the metal insert and the graphite sheet, typically of about 0.07 mm in thickness. The relatively thick layer of adhesive and carrier material tends to cause creep relaxation problems during service. Additionally, the manual knife-cutting procedure is labor intensive and tends to be inaccurate.

In another method, a ring of the graphite sheet is die-cut to the appropriate size and then sprayed with an adhesive. This method can only be used where the metal inserts are available for immediate attachment to the graphite rings, since the adhesive dries rapidly. Additionally, there is often considerable overspray and variability in coating weight, since the spraying of the graphite rings is generally a manual operation.

The present invention provides a new and improved method of forming a gasket, which overcomes the above-referenced problems and others.

### SUMMARY OF THE INVENTION

In accordance with one embodiment of the present invention, a method of forming a gasket is provided. The method includes the steps of: coating a surface of a flexible graphite sheet with a layer of adhesive, covering the layer of adhesive with a release liner, and cutting the graphite sheet and adhesive layer to form a ring-shaped adhesive-backed facing. The ring-shaped adhesive-backed facing is attached to a gasket plate.

In accordance with another embodiment of the present invention, a method of forming a plurality of gaskets is provided. The method includes adhering a layer of an adhesive to a flexible graphite sheet. A gasket plate having a central opening is positioned on the layer of adhesive. A release liner contacts the adhesive layer through the central opening of the plate. At least a first adhesive-backed facing having a central opening is cut from the flexible graphite sheet and adhered layer of adhesive using the plate as a template. A cut-out corresponding to the central opening is removed, the cut-out including a layer of the adhesive-backed flexible graphite and a layer of the release liner. The adhesive-backed facing is adhered to the plate to form a first gasket. A second adhesive-backed facing having a central opening is formed from the cut-out. The second facing is attached to a gasket plate to form a second gasket.

In accordance with yet another embodiment of the present invention, a method of forming a seal between first and second pipe flanges is provided. The method includes applying a layer of adhesive directly to a layer of graphite and sticking a release liner on the layer of adhesive. A portion of the graphite sheet is removed, while leaving the release liner intact, to provide a plurality of annular adhesive-backed facings mounted to the release liner. A first of the annular adhesive-backed facings is detached from the release liner and the first and a second annular adhesive-backed facing are attached to opposed surfaces of a gasket plate. The gasket plate, with attached first and second annular adhesive-backed facings, is clamped between the first and second pipe flanges to form the seal.

In accordance with still another embodiment of the present invention, a gasket which includes a gasket plate is provided. In this embodiment, the gasket includes first and second layers of a flexible graphite sheet. The first and second layers of the flexible graphite sheet are each bonded to an opposed surface of the gasket plate by a layer of adhesive of less than about 0.015 mm in thickness. The adhesive layer is substantially devoid of a carrier within the adhesive layer.

In accordance with a further embodiment of the invention, a method of forming a gasket is provided. The method includes the step of laminating a release liner having an adhesive layer on a first surface of the release liner to a surface of a flexible graphite sheet. The method further includes cutting the flexible graphite sheet and the adhesive layer to form an adhesive backed facing and attaching the adhesive backed facing to a gasket plate.

In accordance with still a further embodiment of the invention a sealing assembly which includes a gasket is provided. The gasket comprises a gasket plate having first and second surfaces. The gasket further includes a first facing comprising a first flexible graphite sheet bonded to the first surface of the gasket plate by a first layer of adhesive. Preferably, the first layer of adhesive is substantially devoid of a carrier within the adhesive layer. The gasket further includes a second facing comprising a second flexible graphite sheet bonded to the second surface of the gasket plate by a second layer of adhesive. The second layer of adhesive is substantially devoid of a carrier within the adhesive layer. The assembly further includes a flange of a first pipe adjacent to the first facing of the gasket and a flange of a second pipe adjacent to the second facing of the gasket

An advantage of at least one embodiment of the present invention is that a flexible graphite facing for a gasket is provided with a sufficiently thin layer of adhesive to resist creep of the gasket facing and to minimize out-gassing when heated.

Another advantage of at least one embodiment of the present invention is that a plurality of gasket facings are attached to a single release liner sheet and can be peeled off as needed.

Still another advantage of at least one embodiment of the present invention is that a cut-out portion from a first gasket seal is provided with a release liner enabling a second gasket to be cut from the cut-out portion at a later time.

Yet another advantage of at least one embodiment is that, by preforming a gasket plate prior to application of a gasket facing, the likelihood of delamination of the facing which tends to occur when the gasket plate is formed from a sheet material after application of the facing is reduced.

Further advantages and embodiments of the present invention will be readily apparent to those skilled in the art, upon a reading of the following disclosure and appended claims, and a review of the accompanying drawings.

### BRIEF DESCRIPTION OF THE DRAWINGS

FIG. 1 is a plan view of a preferred embodiment of a gasket in accordance with the present invention;

FIG. 2 is a cross-sectional view of the gasket of FIG. 1 through 2-2 of FIG. 1, positioned between a pair of pipe flanges, prior to tightening;

FIG. 3 is a perspective view of the gasket of FIGS. 1 and 2 before sealing a flange joint between the two pipes flanges;

FIG. 4 is a cross-sectional view of the gasket of FIG. 2, after tightening;

FIG. 5 is a cross-sectional view of a layer of graphite sheet undergoing roll-coating with a pressure sensitive adhesive in accordance with a first embodiment of the present invention;

FIG. 6 is a cross-sectional view of the adhesive-backed layer of graphite sheet of FIG. 5 with a release liner over the adhesive;

FIG. 7 is a cross-sectional view of the adhesive-backed layer of graphite sheet of FIG. 6 with two dies positioned over facings, after removal of extraneous material;

FIG. 8 is a cross-sectional view of two facings prior to attachment to the gasket plate of FIG. 1;

FIG. 9 is a cross-sectional view of a layer of graphite sheet coated with a pressure sensitive adhesive, showing a die in place for cutting out a facing in accordance with a second embodiment of the present invention;

FIG. 10 is a cross-sectional view of a facing cut from the adhesive-coated layer of graphite sheet of FIG. 9, showing a cut-out portion with release liner;

FIG. 11 is a cross-sectional view of the facing of FIG. 10; and

FIG. 12 shows viscoelastic windows for characteristics of preferred pressure sensitive adhesives.

### DETAILED DESCRIPTION

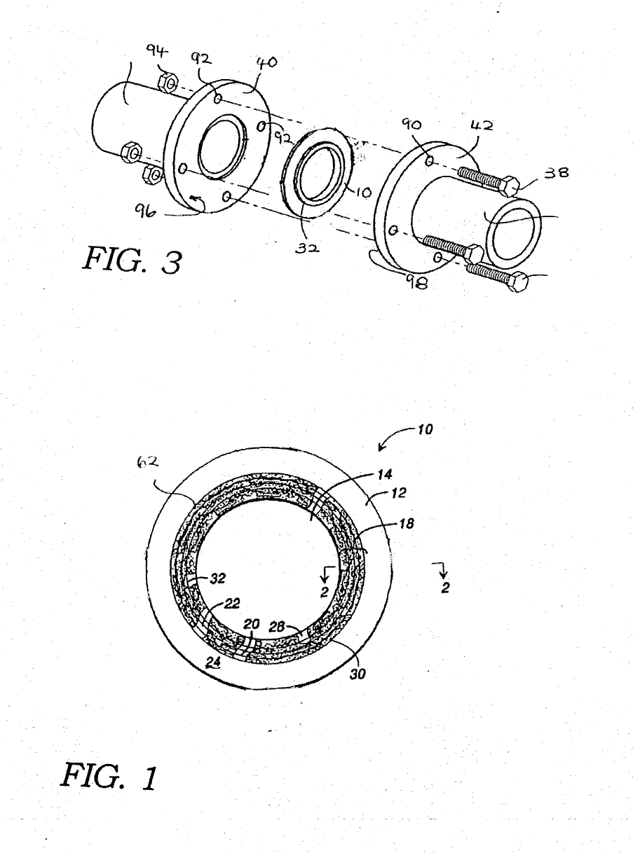

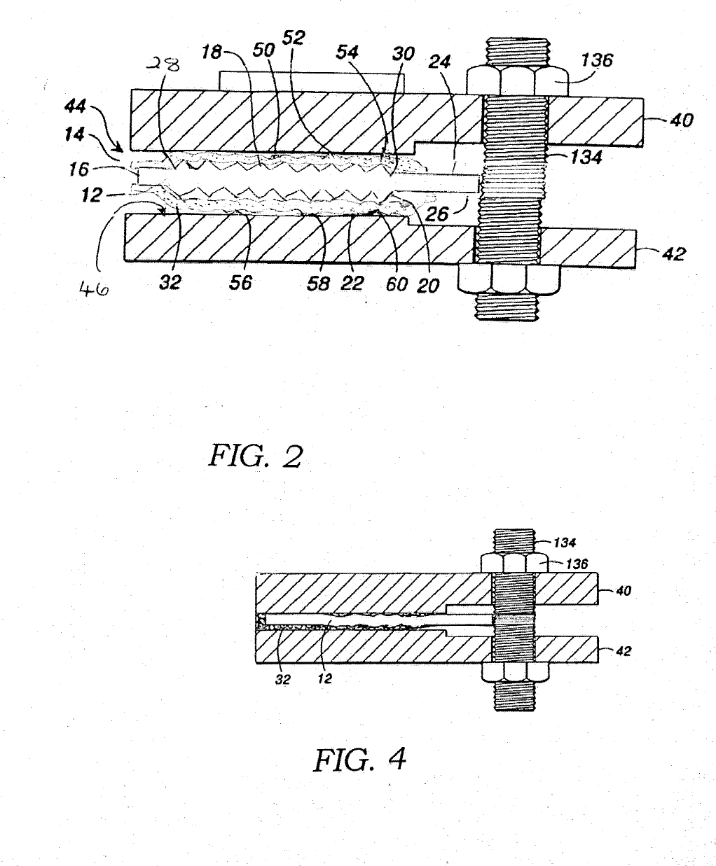

With reference to FIG. 1, a gasket 10 comprises a plate or insert 12 having an annular central opening 14. The annular opening 14 defines an inner rim surface 16 of the plate 12 (FIG. 2). The plate 12 includes an annular region 18, concentric with the central opening 14. The annular region 18 comprises a ridged area for receiving a compressible seal, as discussed below. The annular region 18 includes a plurality of concentric ridges 20 and opposite facing grooves 22 in a first surface 24 and a second surface 26 of the plate 12, as shown FIG. 2. FIG. 2 shows a serrated or “Kammprofile” gasket plate, in which the ridges on one side of the plate coincide with the ridges on the other. It will be appreciated that, alternatively, the gasket may be corrugated, with the grooves offset, such that the grooves 22 on the first surface 24 define the ridges 20 on the second surface 26 of the plate 12, and vice versa.

The gasket plate 12 is formed from metal, or other suitable compressible material. In one embodiment, the thickness of the plate 12 varies across its profile. For example, for Kammprofile gasket plates, the thickness may be between about 0.2 mm and 2 mm away from ridged area 18 and have a maximum thickness in the ridged area 18 of about 2-4 mm, as measured between corresponding ridges 20. The depth of the grooves 22 is typically about 0.6-1.0 mm. For corrugated plates, the plates are usually formed from stainless steel having a thickness which may be between about 0.2 mm and 1 mm, more typically, about 0.4-0.7 mm.

The gasket plate may alternatively be of generally uniform thickness. Gasket plates of generally uniform thickness have applications where fire resistance is advantageous. For example, such gasket plates may be formed from stainless steel plate having a thickness of about 0.3 mm-1.0 mm, more preferably, about 0.5 mm-0.7 mm.

The gasket plate 12 is precut to appropriate dimensions, prior to application of the seal, for example, by cutting with steel-ruled dies or by water jet cutting.

As best shown in FIG. 2, the annular region 18 has a peripheral first edge 28 radially outwardly of the inner rim 16 of the plate and a second edge 30 spaced radially outwardly from the first edge 28. The annular region 18 carries a graphite seal 32 (illustrated in FIG. 1 as covering a portion of the annular region) for making a fluid-tight joint between a pair of flanges in a connection between two pipes, as discussed below. The seal 32 extends along both sides of the corrugated region and may extend slightly inward of the gasket plate 12. Formation of the seal 32 is described in greater detail below. As shown in FIG. 2, the gasket plate 12 is sized to butt up against bolts 38 used for connecting the figures together.

Alternatively, the gasket plate 12 includes pairs of arms spaced apart around the periphery of the plate 12 (not shown). Each pair of arms defines a substantially V-shaped channel for receiving the bolts 38 used for connecting the flanges together.

FIGS. 2 and 4 show the gasket 10 disposed between a pair of flanges 40 and 42, prior to tightening, and after tightening, respectively. The flanges 40 and 42 form a connection 44 between two pipes carrying a fluid. The annular region 18 is spaced radially outwardly of the central opening 14.

Preferably, the seal 32 overlies the annular regions 18 on the first and second surfaces 24 and 26 of the plate 12. Therefore, seal 32 may cover the portions of the plate 12 which are exposed to the fluid communicated through the connection 44. Preferably, seal 32 is in contact with a face 46 of each flange 40, 42. As illustrated in FIG. 2, the ridges 20 together with the seal 32 form discrete sealing areas, e.g., at 50, 52 and 54 on the first surface 24 against the flange 40 and seals 56, 58 and 60 on the second surface 26 against the flange 42 (i.e., adjacent ridges 20).

With reference to FIG. 8, the seal 32 comprises first and second annular facings 62,64. The facings 62,64 are formed from particles of graphite, preferably an expanded intercalated graphite flake. The particles are compressed to form flexible graphite sheets, which are cut into ring-shaped facings 62,64 for attachment to the opposed surfaces 24, 26 of the gasket plate, as described below.

Graphite is a crystalline form of carbon comprising atoms covalently bonded in flat, layered planes with weaker bonds between the planes. By treating particles of graphite, such as natural graphite flake, with an intercalant of, e.g., a solution of sulfuric and nitric acid, the crystal structure of the graphite reacts to form a compound of graphite and the intercalant. The treated particles of graphite are referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e., in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact.

Graphite starting materials suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing “d” between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be intercalated and exfoliated, is suitable for use with the present invention. Such graphite typically has an ash content of less than twenty weight percent. More typically, the graphite employed for the present invention will have a purity of at least about 94%. In certain preferred embodiments, the graphite employed will have a purity of at least about 98%.

A common method for manufacturing graphite sheet is described by Shane, et al. in U.S. Pat. No. 3,404,061, the disclosure of which is incorporated herein by reference. In the typical practice of the Shane, et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g., trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In one specific embodiment, the intercalating agent is a solution of a mixture of sulfuric acid, or sulfuric acid and phosphoric acid, and an oxidizing agent, i.e., nitric acid, perchloric acid, chromic acid, potassium permanganate, hydrogen peroxide, iodic or periodic acids, or the like. The intercalation solution may also contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 150 pph and more typically about 50 to about 120 pph. After the flakes are intercalated, any excess solution is drained from the flakes and the flakes are water-washed. Alternatively, the quantity of the intercalation solution may be limited to between about 10 and about 50 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g., by blending, with a reducing organic agent selected from alcohols, sugars, aldehydes and esters which are reactive with the surface film of oxidizing intercalating solution at temperatures in the range of 25° C. to 125° C. Suitable specific organic agents include hexadecanol, octadecanol, 1-octanol, 2-octanol, decylalcohol, 1,10-decanediol, decylaldehyde, 1-propanol, 1,3 propanediol, ethylene glycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid, and lignin-derived compounds, such as sodium lignosulfate. The amount of organic reducing agent is suitably from about 0.5 to 5% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids, and polycarboxylic acids which have at least 1 carbon atom, and typically up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid, and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative examples of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid, and aromatic dicarboxylic acids such as phthalic acid or terephthalic acid. Representative examples of alkyl esters are dimethyl oxylate and diethyl oxylate. Representative examples of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids, and acetamidobenzoic acids, phenylacetic acid and naphthoic acids. Representative examples of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid, and 7-hydroxy-2-naphthoic acid. Prominent among the polycarboxylic acids is citric acid.

The intercalation solution will generally be aqueous and will typically contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.1% to about 10% by weight of the graphite flake.

After intercalating the graphite flake, and following the blending of the intercalant coated intercalated graphite flake with the organic reducing agent, the blend can be exposed to temperatures in the range of 25° to 125° C. to promote reaction of the reducing agent and intercalant coating. The heating period can be up to as long as about 20 hours, however shorter heating periods may be appropriate for temperatures above the noted range.

The thus treated particles of graphite are sometimes referred to as “particles of intercalated graphite.” Upon exposure to high temperature, e.g., temperatures of at least about 160° C., and especially about 700° C. to 1000° C. and higher, the particles of intercalated graphite expand as much as about 80 to 1000 or more times their original volume in an accordion-like fashion in the c-direction, i.e., in the direction perpendicular to the crystalline planes of the constituent graphite particles. The expanded, i.e., exfoliated, graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact as hereinafter described.

Flexible graphite sheet is coherent, with good handling strength, and are suitably compressed, e.g., by roll-pressing, to a thickness of about 0.01 mm to about 4.00 mm, more preferably about 0.075 mm to about 3.75 mm and a typical density of about 0.1 to 1.5 grams per cubic centimeter (g/cc).

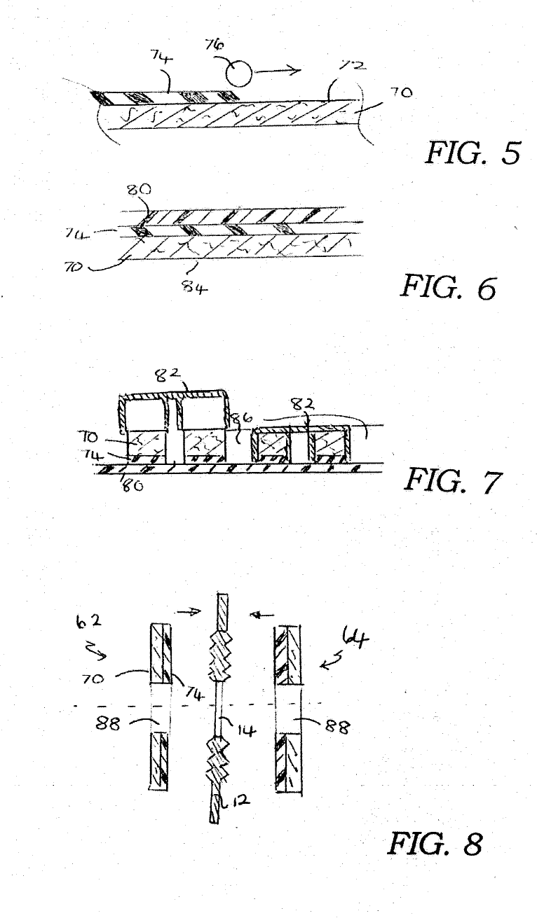

With reference now to FIGS. 5 to 8, a first embodiment of a process for forming the seal 32 is illustrated. A flexible graphite sheet or foil 70, formed as described above, is provided on a first side 72 thereof with a layer 74 of an adhesive (not shown to scale). Preferably, the adhesive is applied in the form of a coating. By “coating,” it is meant that the adhesive is applied as a liquid or viscous fluid to the graphite sheet 70, and is preferably not supported on a backing material prior to its attachment (such as in the form of a double sided tape). The coating is preferably uniform over the graphite sheet surface 72, although it is also contemplated that a discontinuous coating of discretely applied coating regions be used. Suitable adhesives include pressure sensitive adhesives (PSAs). Exemplary PSAs include acrylic based adhesives, such as Gelva® adhesives, manufactured by Solutia Inc., St. Louis, Mo., e.g., Gelva® Multipolymer Resin Emulsion 2896, and Aroset® adhesives, manufactured by Ashland Specialty Chemical Co., Columbus, Ohio, e.g., Aroset® 3250. An example of a general formula for a PSA comprises an elastomeric polymer and optionally a tackifying resin. Other optional components of the PSA may include at least one or more of a filler, an antioxidant, a stabilizer, a cross linking agent, and combinations thereof.

With reference to FIG. 12, in terms of the viscoelastic windows as related to different regions, the PSA preferably has at least one set of coordinates in quadrant 3, i.e., has a dynamic storage modulus (G′) of about 10³ Pa to about 3×10⁴ Pa and a dynamic loss modulus of about 10³ Pa to about less than 5×10⁴ Pa. The PSA may have two or more set of coordinates in quadrant 3. Optionally, the PSA may have 3 or less sets of coordinates in any one of quadrant 3, quadrant 4, the general purpose PSA portion, or any combination thereof.

Other suitable adhesives are described, for example, in U.S. Pat. No. 6,245,400 to Tzeng, et al., which is incorporated herein by reference. Optionally, a primer coating, such as a water-based phenolic/latex adhesive generally less than 0.0025 mm in thickness, typically less than 0.0015 mm, is applied to the graphite surface 72, prior to application of the adhesive. Such a precoat is described, for example, in U.S. Pat. No. 6,245,400 to Tzeng, et al.

Preferably, the adhesive and optionally primer are applied directly to the graphite sheet surface 72 rather than to a carrier material, such as a plastic carrier sheet, which must then applied to the graphite sheet 70 by a second layer of adhesive. In this way the gasket is devoid of or substantially devoid of any form of carrier and the thickness of adhesive can be reduced by having only one layer instead of two.

The graphite sheet 70 typically has a thickness of at least about 0.01 mm, more preferably at least about 0.05 mm. Preferred examples of suitable ranges of thickness of graphite sheet 70 comprise from about 0.02 mm to about 0.15 mm, more preferably about 0.1 mm to 1.0 mm, even more preferably, 0.2 mm to 0.75 mm. The adhesive is applied to the surface 72 as a thin layer 74, preferably less than 0.05 mm on thickness, preferably less than 0.03 mm on thickness, and more preferably, about 0.005 to 0.02 mm in thickness. The adhesive coating may be applied by roll coating, spraying, painting, or the like. A reverse roll coater 76 (FIG. 5) is an effective application device. Optionally, a pre-coat (not shown) is applied to the surface 72 prior to application of the adhesive to enhance bonding of the adhesive to the surface.

In one preferred embodiment, the adhesive is formed as a contiguous layer 74, without there being a plastic carrier between adjacent layers of adhesive. In this way, the resulting gasket 10 is devoid or substantially devoid of a plastic carrier.

A release liner 80 is applied over the adhesive layer 74, as shown in FIG. 6. Any release liner 80 suitable for use with the adhesive may be used. Exemplary release liners 80 include face stocks or other films of polyethylene, polyester, plasticized polyvinyl chloride, polyesters, cellulosics, metal foils, composites, and waxed, siliconized, or other coated paper or plastic having a relatively low surface energy to be removable without appreciable lifting of the adhesive 74 from the graphite sheet 70. A siliconized paper or plastic release liner 80 has been found to be well suited to this purpose. The thickness of the release liner may vary widely, typically ranging from 0.01 mm to 1.0 mm. One suitable release liner is obtained from Loparex Inc., Willowbrook, Ill., under the designation 2-2PESTR-6200. This liner is formed from siliconized polyester and has a thickness of about 0.5 mm.

With reference now to FIG. 7, the assembly of graphite sheet 70, adhesive 74 and liner 80 is positioned with the graphite sheet 70 uppermost. An annular die 82, such as a steel rule die or similar style of sharp die, is placed on top of an exposed surface 84 of the graphite sheet 70. The die is pressed into the graphite sheet 70. Preferably a “kiss-cut” technique is used, by which the unwanted portion of graphite sheet 70, and optionally also adhesive 74, is cut through and removed, while the liner 80 beneath remains intact. The die generally has a rubber hold down or ejection filler to push the cut facing out of the die. The extraneous material 86 or webbing from the spaces around the die 82 is peeled away. In this way, a plurality of ring-shaped facings 62 are left attached to the release liner 80 by adhesive Optionally, the center portion of the webbing inside the ring may be left in place and can be pushed out when the facing 62 is being applied to the gasket plate 12. Alternatively, the cut may not be the “kiss-cut” technique, meaning that the cutting may include cutting the graphite sheet 70, adhesive 74, and liner 80.

To form the seal 32 (FIG. 1), a pair of ring-shaped facings 62, 64 are peeled from the release liner 80. The facings 62 and 64 are positioned adjacent opposite surfaces 24, 26 of the gasket plate 12, as shown in FIG. 8. A central annular transverse opening 88 in each facing 62, 64 is axially aligned with the annular central transverse opening 14 in the gasket plate 12. Slight pressure is applied to adhere the facings 62, 64 to the plate 12 by means of the adhesive 74. The central opening 88 in each facing is preferably of slightly smaller diameter than the opening 14, such that the facing 62,64 extends radially inward of the gasket plate 12 around the opening 14.

The gasket 10 thus formed is then ready to be installed in between flanges 40, 42, as illustrated in FIG. 3. The bolts 38 are positioned through corresponding, aligned bolt holes 90,92 of the flanges 42, 40, respectively. The gasket 10 is positioned such that the bolts 38 about the periphery of the gasket plate or are received in the channels between the pairs of adjacent arms (not shown). Nuts 94 are threaded on the bolts 38 to secure the flanges 40 and 42 together. The tightening of the nuts 94 on the bolts 38 compresses the gasket 10 between opposed faces 96, 98 of the flanges 40 and 42. The graphite sheet of the seal 32 becomes compressed in the areas around the ridges 20, creating a fluid-tight sealing arrangement, as shown in FIG. 4.

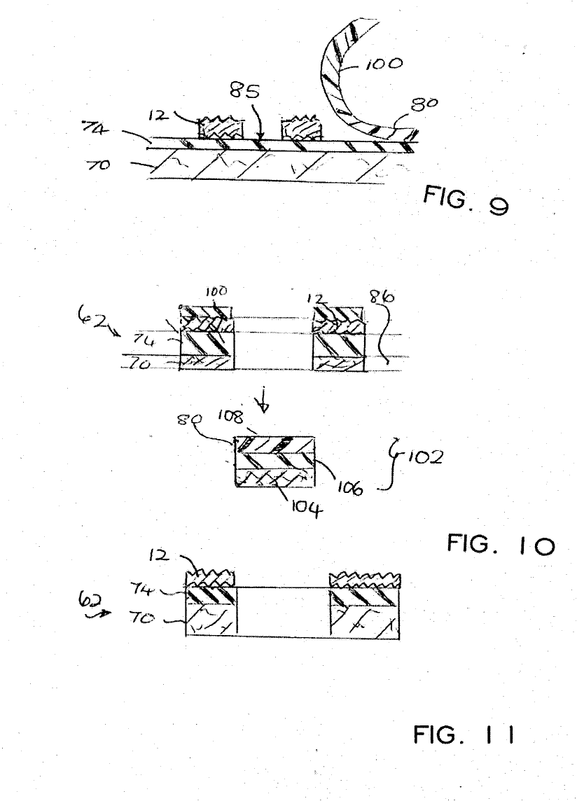

With reference now to FIGS. 9-11, an alternative method of forming the gasket 10 is illustrated. In this embodiment, a layer of adhesive 74 and a release liner 80 are applied to a sheet of graphite sheet 70, as described for the first embodiment (see FIGS. 5 and 6). Although a coating application method is preferred, it is also contemplated that the adhesive may be applied in the form of an adhesive tape (not shown). Such tapes generally include a layer of reinforcement, such as mylar, to which an adhesive is applied on both sides.

In another embodiment, one surface of liner 80 includes a layer of adhesive 74. Preferably, a laminate of liner 80, adhesive 74, and sheet 70 is formed. In this case the laminate may be formed by the use of pressure and optionally, also, heat. However, heat is not required to laminate liner 80 to flexible graphite sheet 70. Optionally, a second release liner having a layer of adhesive may be laminated to a second surface of flexible graphite sheet 70. The second release liner may be laminated to flexible graphite sheet 70 at the same time as liner 80 or at a different time. Preferably, upon removing liner 80 from the laminate, adhesive layer 74 is transferred to flexible sheet of graphite 70. In the case that one adhesive layer is applied to the first surface of flexible graphite sheet 70 and the second adhesive layer to the second surface of flexible graphite sheet 70, a second sheet of flexible graphite may be attached to flexible graphite sheet 70.

When it is desired to form a gasket 10, a portion 100 of the release liner 80 is carefully peeled away from the adhesive layer 74. An annular gasket plate 12 is then positioned on top of the adhesive 74. The liner is then rolled back into position, on top of the gasket plate 12. A facing is cut, for example, by pressing the graphite sheet 70 against the gasket plate 12. The release liner 80 re-sticks to exposed portions 85 of the adhesive. A utility knife or other sharp cutting implement is used to trace around the inside diameter and outside diameter of the gasket plate 12 and cut through both the graphite sheet 70 and release liner 80. A good combination of adhesive 74 and liner 80 for allowing the liner to be re-stickable is an Aroset® adhesive and a Loparex, Inc. siliconized polyester liner, as described above. The polyester, or other plastic used in the release liner, is less susceptible to aging because of humidity and migration of water from the PSA into the liner, than is the case with paper liners. This allows for consistent release properties over a longer time and increased product shelf life. The release liner 80 is much easier to remove when the adhesive is directly applied to the sheet 70, rather than as an adhesive tape.

A portion 86 of the flexible graphite sheet 70, radially outward from plate 12, and the corresponding adhesive, are then peeled away (FIG. 10). The facing 62 attached to the gasket plate 12 (FIG. 11), is inverted over a second portion of the graphite sheet and adhesive to form the second facing 64, in a similar manner to that previously described. The central cut-out portion or drop 102, comprising a circular disk 104 of graphite sheet, a layer of adhesive 106, and a circular piece 108 of release liner 80, can subsequently be reused, at a later date, to form a facing of a smaller outside dimension. The piece 108 of release liner protects the adhesive during storage.

Accordingly, one specific embodiment of the present invention provides a gasket 10 which seals a variety of flanges that differ according to specific application conditions and factors. The gasket uses the desirable attributes of both soft and high density sealing materials without having to design or engineer a specific gasket for each particular flange joint.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

That which is claimed is:

1. A method of forming a gasket comprising:
a. coating a surface of a flexible graphite sheet with a layer of adhesive;
b. covering the layer of adhesive with a release liner;
c. cutting the flexible graphite sheet and adhesive layer to form an adhesive-backed facing; and
d. attaching the adhesive-backed facing to a gasket plate.

2. The method of claim 1, wherein the gasket plate comprises an annular ridged region, the facing is ring-shaped, and the step of attaching comprises: attaching the ring-shaped adhesive-backed facing to the ridged region.

3. The method of claim 1, wherein the step of attaching comprises attaching the adhesive-backed facing to a first side of the gasket plate and attaching a second adhesive-backed facing to a second side of the gasket plate.

4. The method of claim 1,
a. wherein the step of cutting comprises:
1) positioning a die adjacent a second surface of the flexible graphite sheet opposed to the first surface; and
2) cutting the flexible graphite sheet without cutting through the release liner, whereby the ring-shaped adhesive-backed facing remains attached to the release liner; and
b. wherein the step of attaching includes peeling the ring-shaped adhesive-backed facing from the release liner.

5. The method of claim 1, wherein the step of cutting comprises:
a. positioning a die adjacent a second surface of the flexible graphite sheet opposed to the first surface; and
b. cutting the flexible graphite sheet and the release liner, whereby the ring-shaped adhesive-backed facing remains attached to at least a portion of the release liner.

6. The method of claim 1, further comprising, prior to the step of cutting:
a. peeling at least a portion of the release liner away from the adhesive layer;
b. positioning a gasket plate adjacent the layer of adhesive; and
c. reattaching the release liner to areas of the adhesive adjacent the gasket plate.

7. The method of claim 6, wherein the step of cutting further comprises:
a. removing a central portion of adhesive backed flexible graphite sheet, defined radially inward of the gasket plate; and
b. after the step of cutting, forming a second ring-shaped adhesive-backed facing from the central portion.

8. A method of forming a plurality of gaskets comprising:
a. adhering a layer of an adhesive to a flexible graphite sheet;
b. positioning a gasket plate having a central opening on the layer of adhesive;
c. contacting the adhesive layer with a release liner through the central opening of the gasket plate;
d. cutting a first adhesive-backed facing having a central opening from the flexible graphite sheet and adhered layer of adhesive using the gasket plate as a template;
e. removing a cut-out corresponding to the central opening, the cut-out including a layer of the adhesive-backed flexible graphite sheet and a layer of the release liner;
f. forming a first gasket from the facing and gasket plate; and
g. cutting a second adhesive-backed facing having a central opening from the cut-out using a second gasket plate as a template.

9. A sealing assembly comprising:
a. a gasket which comprises:
1) a gasket plate having first and second surfaces,
2) a first facing comprising a first flexible graphite sheet bonded to said first surface of said gasket plate by a first layer of adhesive, said first layer of adhesive substantially devoid of a carrier within the adhesive layer, and
3) a second facing comprising a second flexible graphite sheet bonded to said second surface of said gasket plate by a second layer of adhesive, said second layer of adhesive substantially devoid of a carrier within the adhesive layer;
b. a flange of a first pipe adjacent to said first facing of said gasket; and
c. a flange of a second pipe adjacent to said second facing of said gasket.

10. The sealing assembly of claim 9, wherein the first layer of adhesive has a thickness of less than about 0.05 mm.

11. The sealing assembly of claim 9, wherein the gasket plate has one of a corrugated profile, a serrated profile, and a generally flat profile in a region of the gasket plate attached to the first facing.

12. A gasket comprising:
a. a gasket plate;
b. a first layer comprising a flexible graphite sheet;
c. a second layer comprising a flexible graphite sheet,
wherein the first and second layers of flexible graphite sheet are each bonded to an opposed surface of the gasket plate by a layer of adhesive, and wherein the layer of adhesive has a thickness of less than about 0.03 mm, and is substantially devoid of a carrier.

13. The gasket of claim 12, wherein the gasket plate has one of a corrugated profile, a serrated profile, and a generally flat profile in a region of the gasket plate bonded to said first layer.

14. A method of forming a gasket comprising:
a. laminating a release liner having an adhesive layer on a first surface of the release liner to a surface of a flexible graphite sheet;
b. cutting the flexible graphite sheet and the adhesive layer to form an adhesive backed facing; and
c. attaching the adhesive backed facing to a gasket plate.

15. The method of claim 14, wherein the gasket plate comprises an annular ridged region, the facing is ring-shaped, and said attaching step comprises: attaching the ring-shaped adhesive-backed facing to the ridged region.

16. The method of claim 14,
a. wherein the step of cutting comprises:
1) positioning a die adjacent a second surface of the flexible graphite sheet opposed to the first surface; and
2) cutting the flexible graphite sheet without cutting through the release liner, whereby the ring-shaped adhesive-backed facing remains attached to the release liner; and
b. wherein said attaching includes peeling the ring-shaped adhesive-backed facing from the release liner.

17. The method of claim 14, further comprising, prior to the step of cutting:
a. peeling at least a portion of the release liner away from the adhesive layer;
b. positioning a gasket plate adjacent the layer of adhesive; and
c. reattaching the release liner to areas of the adhesive adjacent the gasket plate.

18. The method of claim 17, wherein the step of cutting further comprises:
a. removing a central portion of adhesive backed flexible graphite sheet, defined radially inward of the gasket plate; and
b. after the step of cutting, forming a second ring-shaped adhesive-backed facing from the central portion.

19. The method of claim 14, further comprising laminating a second release liner having an adhesive layer on a first surface of the second release liner to a second surface of the flexible graphite sheet.

20. The method of claim 19, further comprising adhering a second sheet of flexible graphite to said second surface of the flexible graphite sheet.
